(19) United States
(12) Patent Application Publication
(10) Pub. No.: US 2006/0191678 A1
(43) Pub. Date: Aug. 31, 2006

(54) Evaporator control system

(75) Inventors: Akihisa Sato, Wako-shi (JP); Shigeru Ibaraki, Wako-shi (JP); Masashi Kato, Wako-shi (JP)

Correspondence Address: BIRCH STEWART KOLASCH & BIRCH, PO BOX 747, FALLS CHURCH, VA, 22040-0747, US

(73) Assignee: HONDA MOTOR CO., LTD., Tokyo (JP)

(21) Appl. No.: 11/342,581

(22) Filed: Jan. 31, 2006

(30) Foreign Application Priority Data
Feb. 1, 2005 (JP) 2005-25321

(51) Int. Cl. F01P 7/00; B60H 1/00

(52) U.S. Cl. 165/271; 123/41.02

(57) ABSTRACT

An evaporator control system includes water supply amount control means for controlling at a target temperature the temperature of steam generated by heating water supplied to an evaporator with thermal energy of exhaust gas of an engine, by manipulating the amount of water supplied. The water supply amount controller determines the amount of water supplied to the evaporator based on the sum of a feedforward water supply amount calculated from an amount of change in a parameter representing a load state of the engine, a first feedback water supply amount calculated from the actual temperature of the steam generated by the evaporator, and further a second feedback water supply amount calculated from a parameter representing an internal state of the evaporator such as an internal density of the evaporator.

### CROSS-REFERENCE TO RELATED APPLICATIONS

The present application claims priority under 35 USC 119 to Japanese Patent Application No. 2005-25321 filed on Feb. 1, 2005 the entire contents of which are hereby incorporated by reference.

### BACKGROUND OF THE INVENTION

1. Field of the Invention

The present invention relates to an evaporator control system that includes liquid-phase working medium supply amount control means for controlling at a target temperature the temperature of a gas-phase working medium generated by heating a liquid-phase working medium supplied to an evaporator with thermal energy of exhaust gas of an engine, by manipulating the amount of liquid-phase working medium supplied.

2. Description of the Related Art

Japanese Utility Model Registration Publication No. 2-38162 discloses an arrangement in which the temperature of steam generated by a waste heat once-through boiler using exhaust gas of an engine rotating at a constant speed as a heat source is compared with a target temperature, and when a water supply signal obtained from this deviation is used in feedback control of the amount of water supplied to the waste heat once-through boiler, a feedforward signal obtained by correcting with steam pressure a degree of throttle opening signal of the engine is added to the above-mentioned feedback signal.

As shown in FIG. 14A, water supplied to an evaporator undergoes heat exchange with exhaust gas and forms, in the interior of the evaporator from the upstream side to the downstream side, a water region (liquid phase region), a wet saturated steam region (two phase region), and a superheated steam region (gas phase region). When the interior of the evaporator is at low temperature, since the liquid phase region is large and the gas phase region is small, the density of the working medium in the interior of the evaporator becomes high. When the internal density of the evaporator is high in this way, the heat transfer area of the liquid phase state having a high heat transfer coefficient is large, and a high temperature section in the interior is small. Therefore, as shown in FIG. 14B, if the amount of water supplied to the evaporator is increased stepwise, the steam temperature at the exit of the evaporator decreases with good responsiveness.

In contrast, when the engine is run idle for a long period of time, since the interior of the evaporator attains a high temperature, as shown in FIG. 15A, the liquid phase region is small, and the gas phase region is large, the density of the working medium in the interior of the evaporator becomes low. When the internal density of the evaporator is low in this way, even if the amount of water supplied is increased, it takes more time to decrease the temperature of the interior of the evaporator, as shown in FIG. 15B, the responsiveness is degraded, and due to a large heat transfer area of the gas phase state having a low heat transfer coefficient, the heat exchange efficiency decreases.

As described above, when the interior of the evaporator is at high temperature, controlling the amount of water supplied merely based on the energy of exhaust gas supplied to the evaporator or the temperature of steam coming out of the evaporator gives rise to a problem that the responsiveness becomes low in converging on the target temperature a steam temperature that has risen beyond the target temperature.

### SUMMARY OF THE INVENTION

The present invention has been accomplished under the above-mentioned circumstances, and it is an object thereof to enhance the responsiveness when controlling at a target temperature the temperature of a gas-phase working medium coming out of an evaporator.

A water supply pump 14 of embodiments corresponds to the liquid-phase working medium supply pump of the present invention, and water supply amount control means C of the embodiments corresponds to the liquid-phase working medium supply amount control means of the present invention.

In order to achieve the above-mentioned object, according to a first feature of the invention, there is provided an evaporator control system comprising: liquid-phase working medium supply amount control means for controlling at a target temperature the temperature of a gas-phase working medium generated by heating a liquid-phase working medium supplied to an evaporator with thermal energy of exhaust gas of an engine, by manipulating the amount of the liquid-phase working medium supplied, wherein the liquid-phase working medium supply amount control means determines the amount of liquid-phase working medium supplied to the evaporator based on the sum of a feedforward supply amount of liquid-phase working medium calculated from an amount of change in a parameter representing a load state of the engine, a first feedback supply amount of liquid-phase working medium calculated from the actual temperature of the gas-phase working medium generated by the evaporator, and a second feedback supply amount of liquid-phase working medium calculated from a parameter representing an internal state of the evaporator.

With the first feature, the liquid-phase working medium supply amount control means for controlling the amount of liquid-phase working medium supplied to the evaporator determines the amount of liquid-phase working medium that is to be supplied to the evaporator based on a value obtained by adding not only the feedforward supply amount of the liquid-phase working medium calculated from the amount of change in the parameter representing the load state of the engine and the first feedback supply amount of the liquid-phase working medium calculated from the actual temperature of the gas-phase working medium generated by the evaporator, but also adding thereto the second feedback supply amount of the liquid-phase working medium calculated from the parameter representing the internal state of the evaporator. Therefore, it is possible to enhance the responsiveness when making the temperature of the gas-phase working medium coming out of the evaporator coincide with the target temperature by increasing the amount of liquid-phase working medium supplied.

According to a second feature of the present invention, in addition to the first feature, the parameter representing the load state of the engine comprises at least one of an engine rotational speed, an intake air amount, an air/fuel ratio, an exhaust gas temperature, and an exhaust gas flow rate.

With the second feature, since the parameter representing the load state of the engine comprises the engine rotational speed, the intake air amount, the air/fuel ratio, the exhaust gas temperature, or the exhaust gas flow rate, it is possible to appropriately know the load state of the engine.

According to a third feature of the present invention, in addition to the first feature, the amount of liquid-phase working medium supplied to the evaporator is controlled by at least one of the rotational speed of a liquid-phase working medium supply pump, the degree of opening of an injector provided downstream of the pump, and the degree of opening of a flow rate control valve provided downstream of the pump.

With the third feature, since the amount of liquid-phase working medium supplied to the evaporator is controlled by the rotational speed of the liquid-phase working medium supply pump, the degree of opening of the injector provided downstream of the pump, or the degree of opening of the flow rate control valve provided downstream of the pump, it is possible to appropriately control the amount of liquid-phase working medium supplied.

According to a fourth feature of the present invention, in addition to the first feature, the parameter representing the internal state of the evaporator comprises at least one of a working medium density, a phase change position, a heat transfer coefficient, an overall heat transfer coefficient, a heat transfer amount, and an internal heat storage amount.

With the fourth feature, since the parameter representing the internal state of the evaporator comprises the working medium density, the phase change position, the heat transfer coefficient, the overall heat transfer coefficient, the heat transfer amount, or the internal heat storage amount, it is possible to correctly know the internal state of the evaporator.

The above-mentioned object, other objects, characteristics, and advantages of the present invention will become apparent from preferred embodiments that will be described in detail below by reference to the attached drawings.

### BRIEF DESCRIPTION OF THE DRAWINGS

FIG. 1 to FIG. 10 show a first embodiment of the present invention; FIG. 1 is a diagram showing the overall arrangement of a Rankine cycle system, FIG. 2 is a control block diagram of water supply amount control means, FIG. 3 is a graph showing the relationship between optimum steam temperature and maximum efficiency of an evaporator and an expander, FIG. 4 is a diagram showing a map in which a water supply amount or a gain increase is looked up from an internal density of the evaporator, FIG. 5 is a diagram showing one example of equipment for measuring the internal density of the evaporator, FIG. 6 is a graph showing a temperature distribution of the interior of the evaporator, FIG. 7 is a diagram showing another embodiment of the equipment for measuring the internal density of the evaporator, FIG. 8 is a diagram showing a map in which the internal density is looked up from the response frequency of sound waves in the interior of the evaporator, FIGS. 9A and 9B are graphs showing changes in the internal density and the internal temperature of the evaporator when the amount of water supplied increases, and FIG. 10 is a graph showing changes in the amount of water supplied and the steam temperature when the exhaust gas energy increases. FIG. 11 is a control block diagram of water supply amount control means related to a second embodiment. FIG. 12 is a diagram showing one example of state quantity estimation means. FIG. 13 is a diagram showing another example of the state quantity estimation means. FIGS. 14A and 14B are graphs (at low temperature) showing changes in the internal density and the internal temperature of an evaporator when the amount of water supplied increases in a conventional arrangement. FIGS. 15A and 15B are graphs (at high temperature) showing changes in the internal density and the internal temperature of the evaporator when the amount of water supplied increases in the conventional arrangement.

### DESCRIPTION OF PREFERRED EMBODIMENTS

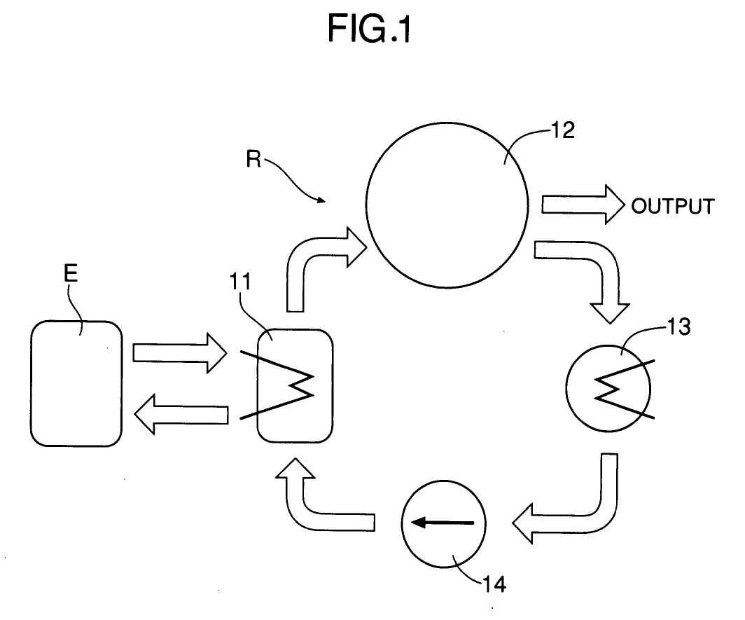

FIG. 1 shows the overall arrangement of a Rankine cycle system R to which the present invention is applied. The Rankine cycle system R, which recovers thermal energy of exhaust gas of an engine E and converts it into mechanical energy, includes an evaporator 11, an expander 12, a condenser 13, and a water supply pump 14, the evaporator 11 heating water with the exhaust gas discharged by the engine E so as to generate high temperature, high pressure steam, the expander 12 being operated by the high temperature, high pressure steam generated by the evaporator 11 so as to generate mechanical energy, the condenser 13 cooling decreased temperature, decreased pressure steam that has completed work in the expander 12 so as to turn it back into water, and the water supply pump 14 pressurizing water discharged from the condenser 13 and re-supplying it to the evaporator 11.

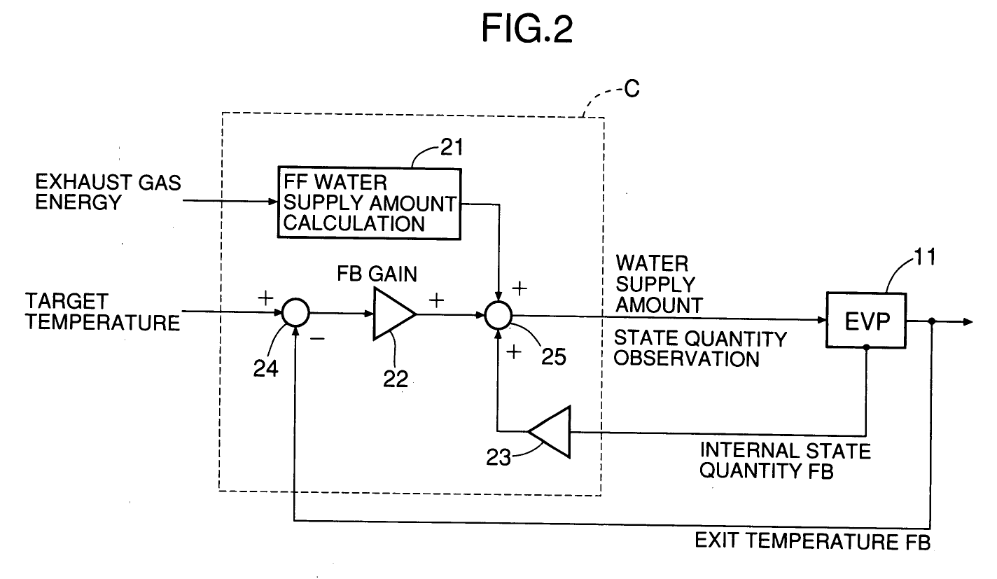

As shown in FIG. 2, water supply amount control means C for controlling with the water supply pump 14 the amount of water supplied to the evaporator 11 includes feedforward water supply amount calculation means 21, first feedback water supply amount calculation means 22, second feedback water supply amount calculation means 23, subtraction means 24, and addition means 25.

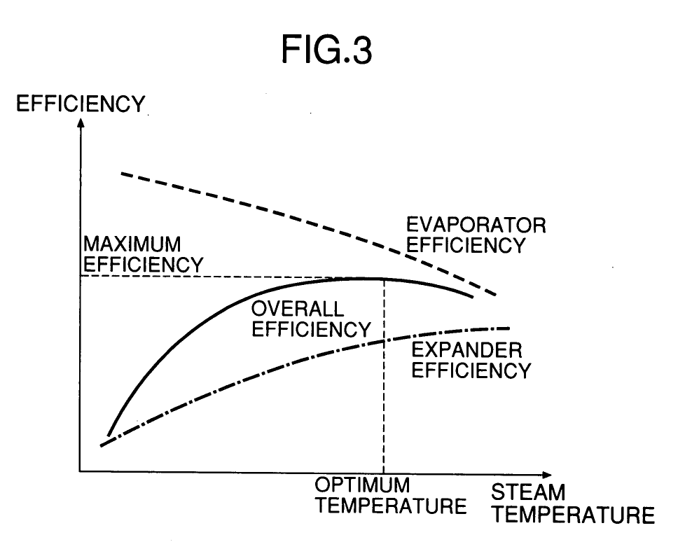

The feedforward water supply amount calculation means 21 calculates, from the exhaust gas energy, a water supply amount for the evaporator 11, that is, a feedforward water supply amount. The subtraction means 24 calculates a deviation of an actual temperature (an exit temperature) from a target temperature of steam generated by the evaporator 11. The target temperature for the steam is determined as follows. That is, as shown in FIG. 3, the efficiency of the evaporator 11 and the efficiency of the expander 12 of the Rankine cycle system change according to changes in the steam temperature; when the steam temperature increases, the efficiency of the evaporator 11 decreases and the efficiency of the expander 12 increases, whereas when the steam temperature decreases, the efficiency of the evaporator 11 increases and the efficiency of the expander 12 decreases. Therefore, an optimum steam temperature at which the overall efficiency of the two becomes a maximum is defined as the target temperature. The first feedback water supply amount calculation means 22 multiplies the deviation by a predetermined gain to thus calculate a first feedback water supply amount.

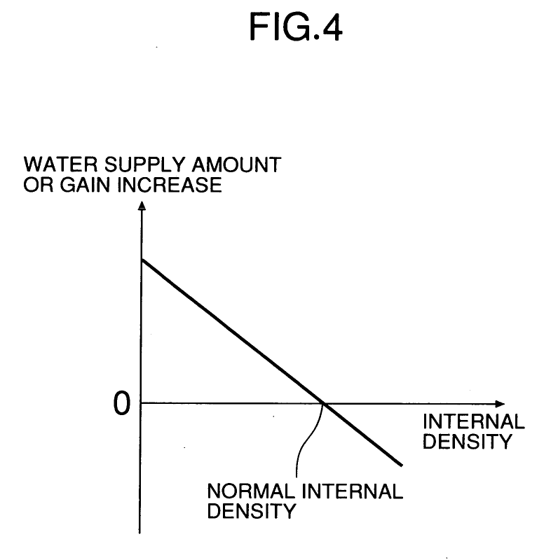

The internal density, which is an internal state, of the evaporator 11 is inputted into the second feedback water supply amount calculation means 23, and a second feedback water supply amount (an increase in the water supply amount) is calculated therein using the map shown in FIG. 4. When the internal density of the evaporator 11 is a normal value, the second feedback water supply amount is set at 0, and the second feedback water supply amount decreases or increases in response to an increase or a decrease in the internal density. The feedforward water supply amount, the first feedback water supply amount, and the second feedback water supply amount are added by the addition means 25, and water is supplied to the evaporator 11 at the total water supply amount.

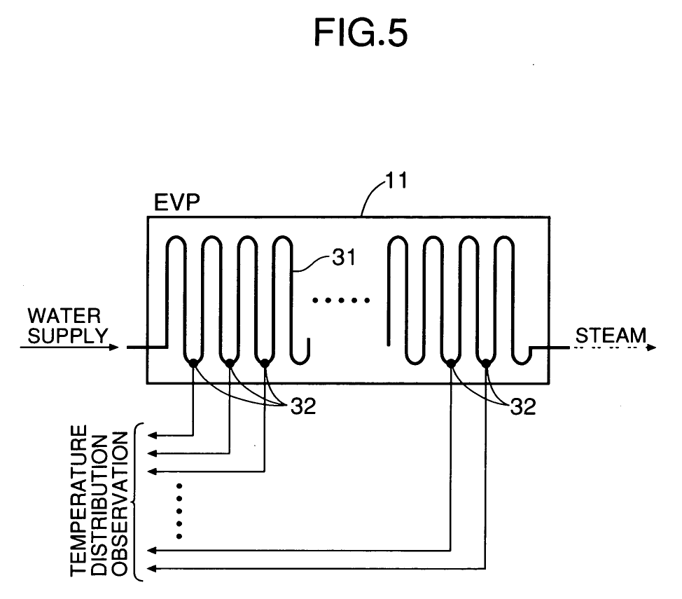

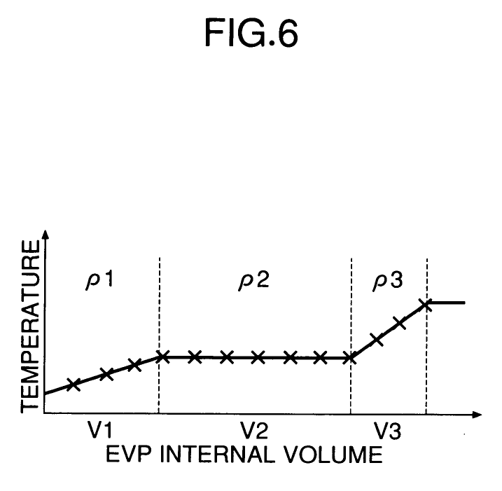

A first measurement method for the internal density of the evaporator 11 includes providing a plurality of temperature sensors 32 at predetermined intervals on a pipe 31 in the interior of the evaporator 11 as shown in FIG. 5, and observing a temperature distribution. The graph of FIG. 6 shows observation results where the volume of a liquid phase region, in which the temperature gradually increases, is V1; the volume of a two phase region, in which the temperature is constant, is V2; the volume of a gas phase region, in which the temperature gradually increases, is V3; and average densities ρ1, ρ2, and ρ3 of the respective regions are calculated from the temperature distribution and pressure. An average internal density p of the entire evaporator 11 is calculated from
(ρ1*V1+ρ2*V2+ρ3*V3)/V
in which V denotes the overall volume of the evaporator 11.

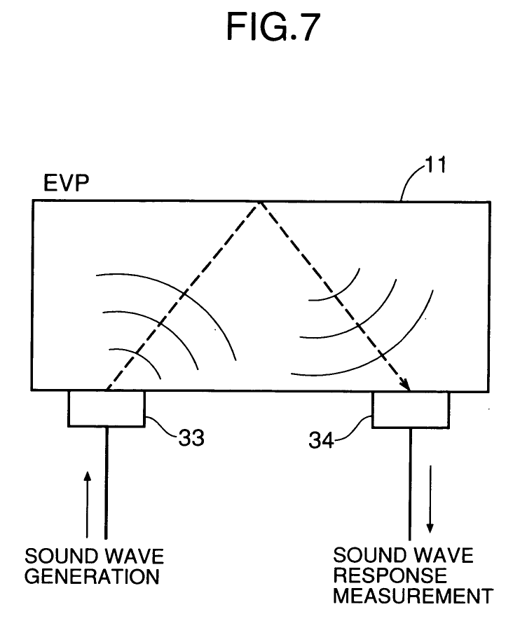

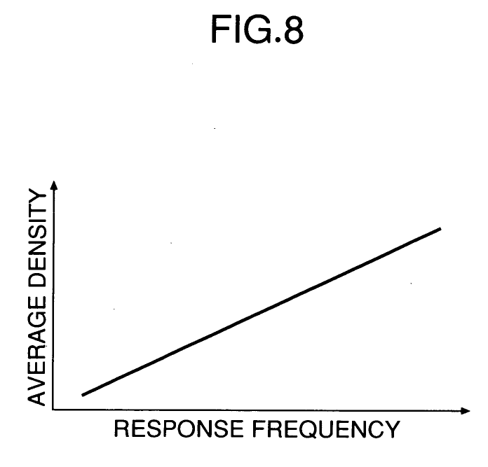

A second measurement method for the internal density of the evaporator 11 includes providing a sound wave generator 33 and a sound wave response meter 34 in the interior of the evaporator 11 as shown in FIG. 7, the sound wave response meter 34 receiving reflected waves of sound waves emitted by the sound wave generator 33 and reflected from the interior of the evaporator 11, and applying the response frequency of the reflected waves to the map of FIG. 8. The internal density increases according to an increase in the response frequency. The embodiment of FIG. 4 is a case in which the internal density increases linearly. Instead of the sound wave generator 33, sound of rotation of the engine may be used.

As hereinbefore described, the amount of water supplied is controlled using not only input/output information of the evaporator 11 such as the exhaust gas energy, the target temperature for the steam, or the actual temperature of the steam but also internal information such as the internal density of the evaporator 11. Therefore, when there is a possibility that the responsiveness of control of the steam temperature might be degraded due to low internal density of the evaporator 11 (ref. FIGS. 15A and 15B), the responsiveness can be increased.

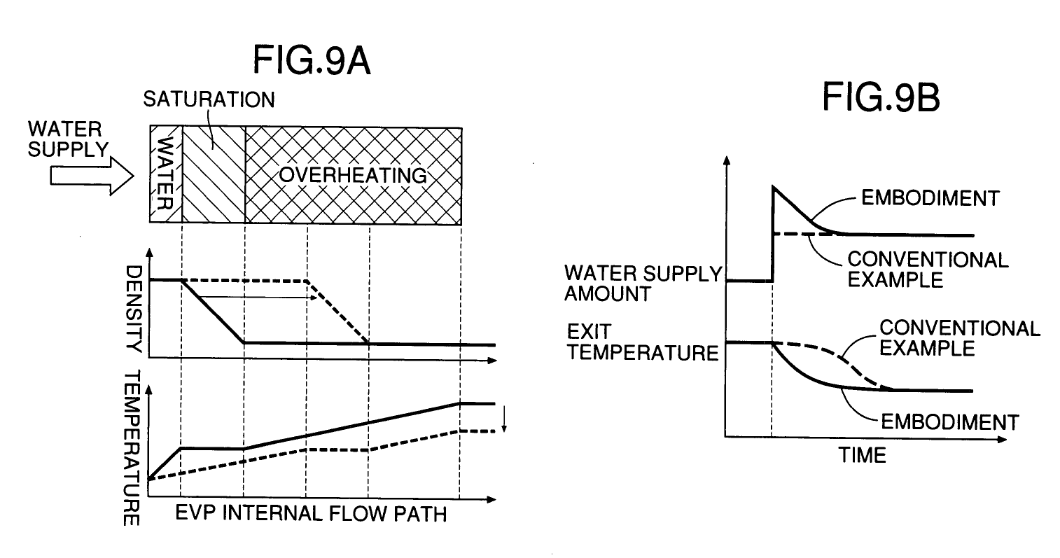

That is, as shown in FIG. 9A, when the internal density of the evaporator 11 is high, then as shown by the solid line in FIG. 9B, by making the water supply amount have a peak when it rises in comparison with a conventional example (ref. the dashed line) to thus increase the internal density of the evaporator 11 quickly and decrease the steam temperature quickly, the steam temperature can be converged on the target temperature with good responsiveness.

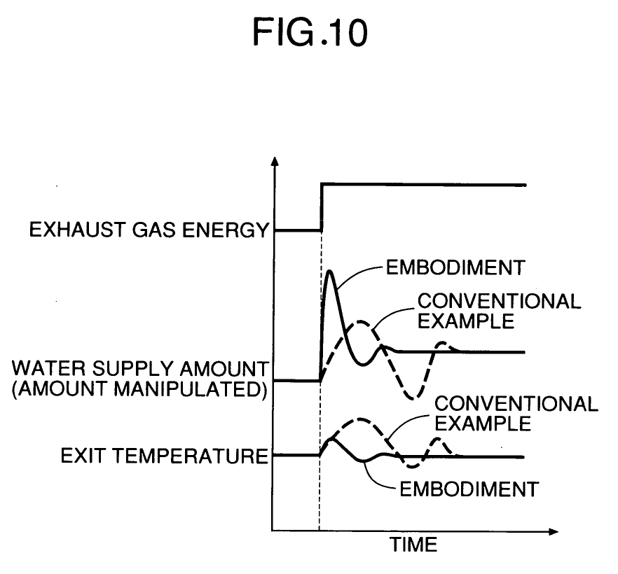

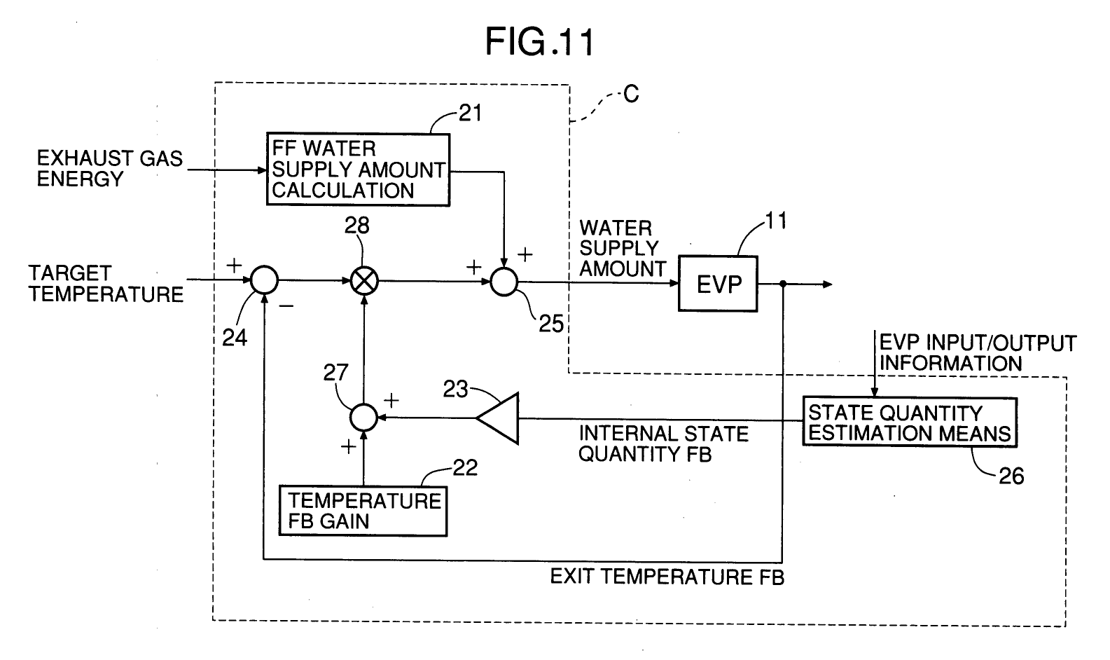

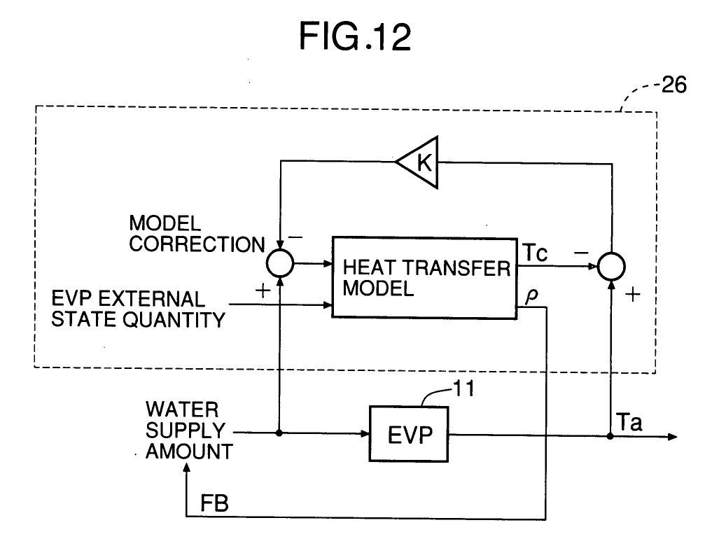

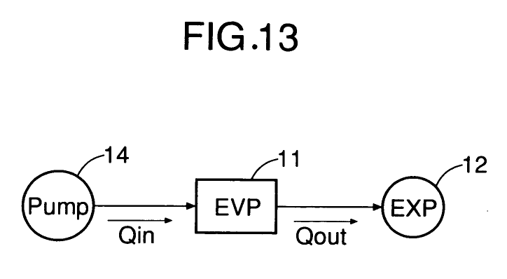

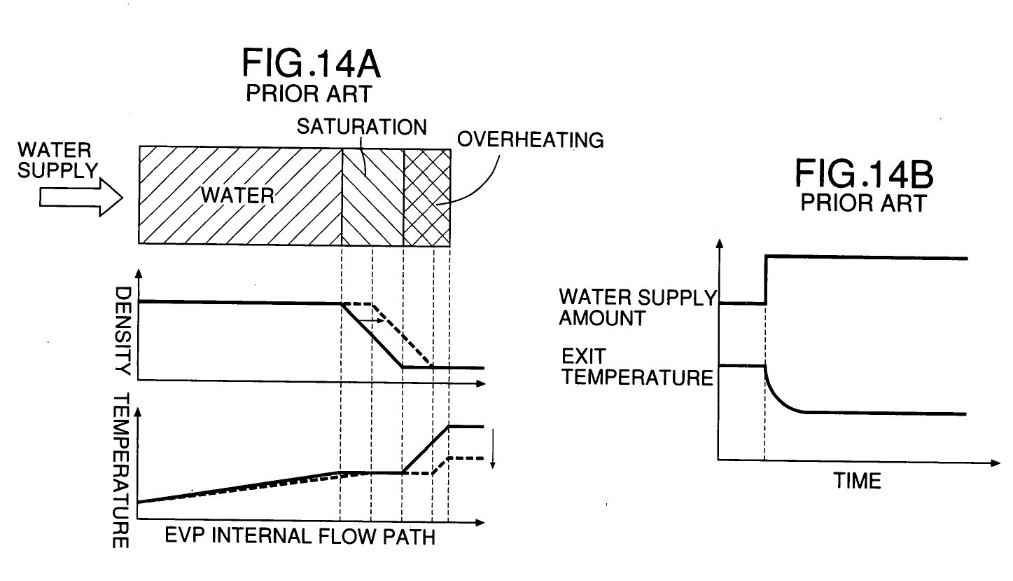

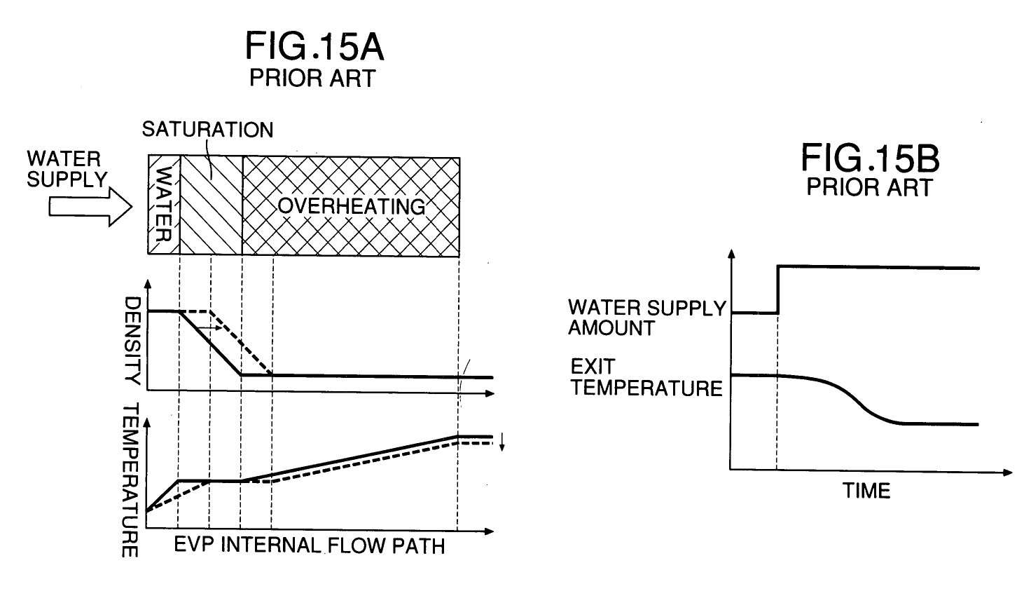

FIG. 10 shows the characteristics of change in the water supply amount and the characteristics of the responsiveness of the exit temperature of the evaporator 11 when the exhaust gas energy is increased stepwise. The water supply amount increases quickly in comparison with a conventional example, and as a result it can be seen that the deviation of the exit temperature of the evaporator 11 from the target temperature becomes small, and the exit temperature converges on the target temperature quickly.

FIG. 11 to FIG. 13 show a second embodiment of the present invention; FIG. 11 is a control block diagram of water supply amount control means, FIG. 12 is a diagram showing one example of state quantity estimation means, and FIG. 13 is a diagram showing another example of the state quantity estimation means.

As shown in FIG. 11, water supply amount control means C for controlling the amount of water supplied to an evaporator 11 includes feedforward water supply amount calculation means 21, first feedback water supply amount calculation means 22, second feedback water supply amount calculation means 23, subtraction means 24, addition means 25, state quantity estimation means 26, addition means 27, and multiplication means 28. The feedforward water supply amount calculation means 21, the first feedback water supply amount calculation means 22, the second feedback water supply amount calculation means 23, and the subtraction means 24 have the same functions as those of the first embodiment.

In the first embodiment, the internal density p of the evaporator 11 is determined by actual measurement, but in the second embodiment an internal density p of the evaporator 11 is estimated by the state quantity estimation means 26 using a calculation model shown in FIG. 12. That is, a heat transfer equation representing a heat transfer model of the evaporator 11 is solved in real time, thereby determining the internal density p and a calculated exit temperature Tc, which are internal variables of the evaporator 11. The internal density p is used for feedback control of the water supply amount for the evaporator 11, and the calculated exit temperature Tc is corrected using a difference from an actual exit temperature Ta of the evaporator 11 and inputted for feedback control.

Returning to FIG. 11, the internal density p estimated by the state quantity estimation means 26 is inputted into the second feedback water supply amount calculation means 23, which calculates a second feedback gain (an increase in gain) using the map shown in FIG. 4 as a gain map. After the addition means 27 adds this second feedback gain to a first feedback gain outputted by the first feedback water supply amount calculation means 22, the multiplication means 28 multiplies the sum by the deviation of the exit temperature (actual temperature) from the target temperature, thus calculating a feedback water supply amount. The addition means 25 adds this feedback water supply amount to a feedforward water supply amount to give a final water supply amount.

This second embodiment can also achieve the same operational effects as those of the first embodiment described above.

FIG. 13 shows another example of the state quantity estimation means 26.

This state quantity estimation means 26 observes a flow rate Qin of water supplied from the water supply pump 14 to the evaporator 11 and a flow rate Qout of steam supplied from the evaporator 11 to an expander 12 using a flowmeter; and calculates an internal density p of steam in the interior of the evaporator 11 from
ρ=∫{Qin(t)−Qout(t)}dt/V.

Although embodiments of the present invention have been described above, the present invention can be modified in a variety of ways as long as the modifications do not depart from the spirit and scope of the present invention.

For example, in the embodiments the exhaust gas energy is used as a parameter representing the load state of the engine E, but any of the engine rotational speed, the intake air amount, the air/fuel ratio, the exhaust gas temperature, and the exhaust gas flow rate may be used.

Furthermore, in the embodiments the amount of water supplied to the evaporator 11 is controlled by the rotational speed of the water supply pump 14, but it may be controlled by the degree of opening of an injector provided downstream of the water supply pump 14, or the degree of opening of a flow rate control valve provided downstream of the water supply pump 14.

Moreover, in the embodiments the internal density p is used as a parameter representing the internal state of the evaporator 11, but any of a phase change position, a heat transfer coefficient, an overall heat transfer coefficient, a heat transfer amount, and an internal heat storage amount of the evaporator 11 may be used.

What is claimed is:

1. An evaporator control system comprising:
liquid-phase working medium supply amount control means for controlling at a target temperature the temperature of a gas-phase working medium generated by heating a liquid-phase working medium supplied to an evaporator with thermal energy of exhaust gas of an engine, by manipulating the amount of the liquid-phase working medium supplied,
wherein the liquid-phase working medium supply amount control means determines the amount of liquid-phase working medium supplied to the evaporator based on the sum of a feedforward supply amount of liquid-phase working medium calculated from an amount of change in a parameter representing a load state of the engine, a first feedback supply amount of liquid-phase working medium calculated from the actual temperature of the gas-phase working medium generated by the evaporator, and a second feedback supply amount of liquid-phase working medium calculated from a parameter representing an internal state of the evaporator.

2. The evaporator control system according to claim 1, wherein the parameter representing the load state of the engine comprises at least one of an engine rotational speed, an intake air amount, an air/fuel ratio, an exhaust gas temperature, and an exhaust gas flow rate.

3. The evaporator control system according to claim 1, wherein the amount of liquid-phase working medium supplied to the evaporator is controlled by at least one of the rotational speed of a liquid-phase working medium supply pump, the degree of opening of an injector provided downstream of the pump, and the degree of opening of a flow rate control valve provided downstream of the pump.

4. The evaporator control system according to claim 1, wherein the parameter representing the internal state of the evaporator comprises at least one of a working medium density, a phase change position, a heat transfer coefficient, an overall heat transfer coefficient, a heat transfer amount, and an internal heat storage amount.
